(19) United States
(12) Patent Application Publication
(10) Pub. No.: US 2013/0311915 A1
(43) Pub. Date: Nov. 21, 2013

(54) UI CREATION SUPPORT SYSTEM, UI CREATION SUPPORT METHOD, AND NON-TRANSITORY STORAGE MEDIUM

(71) Applicants: Shunsuke Suzuki, Tokyo (JP); Ryosuke Okubo, Tokyo (JP); Yukiko Tanikawa, Tokyo (JP)

(72) Inventors: Shunsuke Suzuki, Tokyo (JP); Ryosuke Okubo, Tokyo (JP); Yukiko Tanikawa, Tokyo (JP)

(73) Assignee: NEC CORPORATION, Tokyo (JP)

(21) Appl. No.: 13/982,059

(22) PCT Filed: Nov. 29, 2011
(86) PCT No.: PCT/JP2011/006633

§ 371 Date: Jul. 26, 2013

(30) Foreign Application Priority Data
Jan. 27, 2011 (JP) 2011-015439

(51) Int. Cl. G06F 3/0481

(52) U.S. Cl. CPC G06F 3/0481
USPC 715/763

(57) ABSTRACT

A UI creation support system is provided which supports creation of a user interface (UI) screen and which includes an organization-effect correlation rule storage unit (10) that stores an organization-effect correlation rule in which at least one UI effect that is realized by a plurality of UI effect realizing organizations which can be given to the UI screen is correlated with each of the plurality of UI effect realizing organizations, a user input receiving unit (16) that receives specification information, which is information for specifying at least one UI effect to be held by the UI screen, from a design user who is a user creating the UI screen, and a UI effect realizing organization determining unit (11) that retrieves the organization-effect correlation rule using the UI effect specified by the specification information of which the input is received by the user input receiving unit (16) as a key and that extracts the UI effect realizing organization correlated with the key.

### TECHNICAL FIELD

The present invention relates to a UI creation support system, a UI creation support method, and a program.

### BACKGROUND ART

A user (hereinafter, referred to as a “design user”) creating a UI screen needs to understand how a user (hereinafter, referred to as an “assumed user”) will use the UI screen and to design the UI screen suitable for the assumed user. However, it is not easy to design a UI screen suitable for an assumed user. The number of assumed users may be one or may be two or more.

Patent Document 1 discloses an information processing apparatus that receives a request from a client terminal via a network, that provides a variety of information to the client terminal in response to the received request, that stores plural GUI data pieces correlated with levels of assumed users as GUI data for providing plural kinds of graphical user interfaces (GUI) having different organizations, and that dynamically changes a UI depending on the level of an assumed user.

Patent Document 2 discloses an information retrieving method and an apparatus thereof which can easily retrieve information desired by a group including plural users out of a large number of programs by determining the priority of information as the group on the basis of basic choice preferences unique to the plural users.

Patent Document 3 discloses an attribute determining apparatus including a storage unit that classifies words in the form of hierarchies depending on semantic analogous relationships of words in each of plural hierarchies and that stores classification information in which classification names based on the semantic analogous relationships are given to classifications of the hierarchies and a determination unit that determines an attribute of a concept indicated by a conceptual word of a determination target on the basis of determination conditions on the classification names for determining attributes, which are defined in advance for the plural attributes including classification names allocated to classifications of the determination target after conceptualization and determined on the basis of the classification information, modalities, and degrees.

Patent Document 4 discloses a processing system which is used along with a user interface display.

### RELATED DOCUMENT

### Patent Document

[Patent Document 1] Japanese Unexamined Patent Publication No. 2004-355418

[Patent Document 2] Japanese Unexamined Patent Publication No. H10-162028

[Patent Document 3] Japanese Unexamined Patent Publication No. 2009-3811

[Patent Document 4] PCT Japanese Translation Patent Publication No. 2005-521161

### DISCLOSURE OF THE INVENTION

In the technique of dynamically changing a UI screen described in Patent Document 1, the configuration of a UI screen is complicated. In order to individually cope with various assumed users, plural UI screens have to be prepared, thereby increasing a cost load.

In the techniques disclosed in Patent Documents 2 to 4, an effect of facilitating design of a UI screen suitable for an assumed user cannot be expected.

An object of the present invention is to easily design a UI screen suitable for an assumed user.

According to an aspect of the present invention, there is provided a UI creation support system that supports creation of a user interface (UI) screen, including: an organization-effect correlation rule storage unit that stores an organization-effect correlation rule in which at least one UI effect that is realized by a plurality of UI effect realizing organizations which can be given to the UI screen is correlated with each of the plurality of UI effect realizing organizations; a user input receiving unit that receives specification information, which is information for specifying at least one UI effect to be held by the UI screen, from a design user who is a user creating the UI screen; and a UI effect realizing organization determining unit that retrieves the organization-effect correlation rule using the UI effect specified by the specification information of which the input is received by the user input receiving unit as a key and that extracts the UI effect realizing organization correlated with the key.

According to another aspect of the present invention, there is provided a UI creation support method of supporting creation of a UI screen, including: a step of storing an organization-effect correlation rule in which at least one UI effect that is realized by a plurality of UI effect realizing organizations which can be given to the UI screen is correlated with each of the plurality of UI effect realizing organizations; a user input receiving step of receiving specification information, which is information for specifying at least one UI effect to be held by the UI screen, from a design user who is a user creating the UI screen; and a UI effect realizing organization determining step of retrieving the organization-effect correlation rule using the UI effect specified by the specification information of which the input is received in the user input receiving step as a key and extracting the UI effect realizing organization correlated with the key.

According to still another aspect of the present invention, there is provided a program that supports creation of a UI screen, causing a computer to serve as: an organization-effect correlation rule storage unit that stores an organization-effect correlation rule in which at least one UI effect that is realized by a plurality of UI effect realizing organizations which can be given to the UI screen is correlated with each of the plurality of UI effect realizing organizations; a user input receiving unit that receives specification information, which is information for specifying at least one UI effect to be held by the UI screen, from a design user who is a user creating the UI screen; and a UI effect realizing organization determining unit that retrieves the organization-effect correlation rule using the UI effect specified by the specification information of which the input is received by the user input receiving unit as a key and that extracts the UI effect realizing organization correlated with the key.

According to the aspects of the present invention, it is possible to easily design a UI screen suitable for an assumed user.

### BRIEF DESCRIPTION OF THE DRAWINGS

The above-mentioned object and other objects, features, and advantages will become apparent with reference to the following exemplary embodiments and the accompanying drawings.

FIG. 1 is a functional block diagram illustrating an example of a UI creation support system according to an embodiment.

FIG. 2 is a diagram illustrating an example of an organization-effect correlation rule according to the embodiment.

FIG. 3 is a diagram illustrating an example of a characteristic-effect correlation rule according to the embodiment.

FIG. 4 is a diagram illustrating an example of a characteristic-classification correlation rule according to the embodiment.

FIG. 5 is a flowchart illustrating an example of a process flow of a UI creation support method according to the embodiment.

FIG. 6 is a functional block diagram illustrating an example of a UI creation support system according to an embodiment.

FIG. 7 is a functional block diagram illustrating an example of a UI creation support system according to an embodiment.

FIG. 8 is a diagram illustrating an example of first coexistence unallowable information according to the embodiment.

FIG. 9 is a diagram illustrating an example of second coexistence unallowable information according to the embodiment.

### DESCRIPTION OF EMBODIMENTS

Hereinafter, embodiments of the present invention will be described with reference to the accompanying drawings.

Units in the embodiments are embodied by any combination f hardware and software based on a CPU and a memory of a computer, a program (including a program downloaded from a storage medium such as a CD or a server in the Internet or the like, in addition to a program stored in advance in the memory at the shipment thereof) loaded into the memory, a storage unit such as a hard disk storing the program, and a network access interface. It will be understood by those skilled in the art that the method and apparatus for embodiment thereof can be modified in various forms.

The functional block diagrams used to describe the embodiments do not show blocks of hardware units but blocks of functional units. In the drawings, each unit according to the embodiments is shown to be embodied by a single device, but the embodiment unit thereof is not limited thereto. That is, the configurations may be divided physically or may be divided logically.

### First Embodiment

First, the summary of this embodiment will be described below.

A UI creation support system according to this embodiment receives an input of an assumed user classification, to which an assumed user using a UI screen in design belongs, from a design user creating the UI screen. Examples of the assumed user classification include “adult”, “university student”, “junior and senior high-school student”, “female high-school student”, and “manager”. Then, the UI creation support system determines UI effect realizing organizations to be included by a UI screen of an assumed user belong to the assumed user classification of which the input is received.

According to this embodiment, the design user can determine the UI effect realizing organizations to be included by the UI screen by understanding the user classification of an assumed user and inputting the understood user classification to the UI creation support system according to this embodiment.

The configuration of this embodiment will be described in detail below.

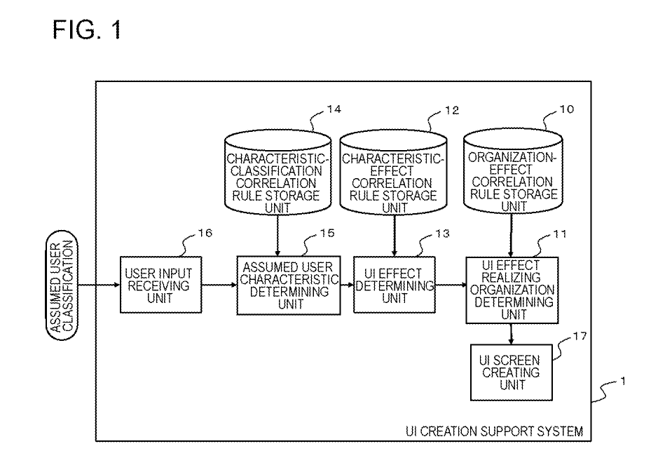

FIG. 1 is a functional block diagram illustrating an example of a configuration of the UI creation support system 1 according to this embodiment. The UI creation support system 1 according to this embodiment includes an organization-effect correlation rule storage unit 10, a UI effect realizing organization determining unit 11, a characteristic-effect correlation rule storage unit 12, a UI effect determining unit 13, a characteristic-classification correlation rule storage unit 14, an assumed user characteristic determining unit 15, a user input receiving unit 16, and a UI screen creating unit 17. The UI screen creating unit 17 may not be provided. The units will be described below.

The organization-effect correlation rule storage unit 10 stores an organization-effect correlation rule in which at least one UI effect to be realized by the corresponding UI effect realizing organization is correlated with each of plural UI effect realizing organizations which can be given to a UI screen.

The UI effect realizing organizations are organizations of a UI screen and examples thereof include organizations such as an “organization for realizing a help function”, an “organization for realizing a function of providing an operation manual of a UI screen or the like on a screen”, an “organization for realizing a function of displaying a flow of UI screen operations as a moving image on a screen”, an “organization for realizing a function of converting a Japanese transcription into a foreign-language transcription such as an English transcription”, an “organization for realizing an audio guidance function”, an “organization for realizing a function of allowing a user to customize colors of a UI screen”, an “organization for realizing a function of allowing a user to customize sizes of characters on a UI screen”, an “organization for realizing a display function of displaying a Japanese transcription and a foreign-language transcription in parallel”, an “organization for realizing a display function of enabling intuitive understanding of an operation method using a lot of figures”, an “organization for realizing an operating function using a keyboard”, an “organization for realizing an operating function using a touch”, an “organization for realizing an operating function using a touch pen”, an “organization for realizing an operating function using a mouse”, an “organization for realizing an operating function using a cursor”, an “organization for realizing a color changing function for each subsystem”, an “organization for realizing an auto-completing function”, an “organization for realizing a data input function using a calendar”, an “organization for realizing an address input function using a postal code”, an “organization for realizing a graph display function”, an “organization for realizing an animation effect function of a graph”, an “organization for realizing a cold and low-chroma coloring function”, an “organization for realizing a wizard format”, an “organization for realizing use of multiple icons”, an “organization for realizing an English base”, an “organization for realizing a Chinese base”, an “organization for realizing a Korean base”, an “organization for realizing a French base”, an “organization for realizing a Spanish base”, an “organization for realizing an input details confirming function”, an “organization for realizing an auto-save function”, an “organization for realizing a display and input supporting function using a tactile sense”, a “resolution level (such as high, middle, and low)”, an “undo level (such as large, and middle small)”, a “contrast level (such as high, middle, and low)”, an “accessibility-based level (such as high, middle, and low)”, a “design level (such as high, middle, and low)”, a “mounting platform (such as Ajax, Silverlight, and HTML)”, a “help format (such as index help and context-dependent help)”, an “explanation area in a screen (such as only necessary location and entire screen)”, a “response to a change in length of a character string (such as use of abbreviation and change of a layout)”, and a “language switching method (such as initial setting and dynamic switching)”. The UI effect realizing organizations in this embodiment can include all UI effect realizing organizations which can be realized in the related art.

The “index help” in the help format is an organization for displaying contents of help details and allowing a user to select necessary help details therefrom when the help function is called by the user. The “context-dependent help” is an organization for allowing a computer to recognize a screen display at the time point at which the help function is called by a user and displaying help details associated with the screen display. The “explanation area in a screen” is an organization for defining an amount of information to be input or an amount of information such as an input method to be displayed. The “only necessary location” is an organization for selectively making a display at only a necessary location on the UI screen. The “entire screen” is an organization for displaying the above-mentioned information at all the locations on the screen. The “response to a change in length of a character string” is a treating method, for example, when a limited space such as a text label is changed by a user's operation in an organization for displaying predetermined information in the limited space. The “use of abbreviation” is an organization for reducing the number of characters by displaying some of information to be displayed as abbreviations and displaying a reduced character string in the changed space when the space is changed in a narrowing direction. The “change of a layout” is an organization for changing a display layout of a character string to guarantee a display space for the character string. The “initial setting” in the language switching method is an organization for allowing a user to switch a language at the time of start of a UI screen. The “dynamic switching” is an organization for allowing a user to switch a language when a predetermined operation is being performed through a UI screen.

The UI effect realizing organization which can be given to a UI screen corresponds to a UI effect realizing organization picked up as a candidate to be given to the UI screen in consideration of circumstances such as usages of the UI screen to be designed, use situations thereof, and a budget out of all the UI effect realizing organizations which can be realized in the related art. What UI effect realizing organization to use as the UI effect realizing organization which can be given to the UI screen is a design matter.

A UI effect is an effect realized by each UI effect realizing organization and is an effect to be provided to an assumed user. It is preferable that details of the UI effects recorded on the organization-effect correlation rule be able to be freely prepared so as not to be inconsistent with truth but be set to details which can be easily understood by a design user.

For example, when a UI effect realizing organization is the “organization for realizing a function of displaying a flow of UI screen operations as a moving image on a screen”, the UI effect correlated with the UI effect realizing organization may be set to “sufficient operation support”, “being easily operated by a foreigner”, “being easily understood by a person poor at a mechanical operation such as an old person”, or the like. These details are only examples and the UI effects are not limited to these examples.

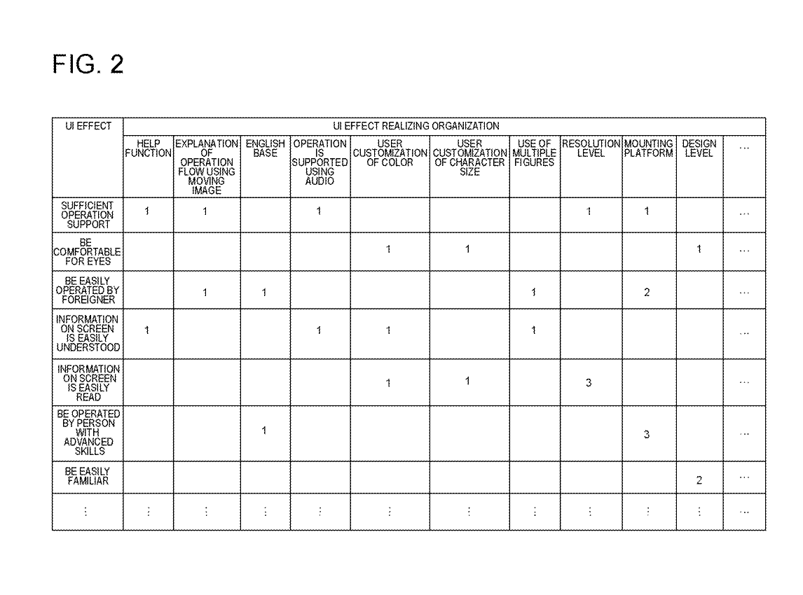

An example of the organization-effect correlation rule stored in the organization-effect correlation rule storage unit 10 is shown in FIG. 2. UI effect realizing organizations which are picked up as a candidate to be given to a UI screen are described in the organization-effect correlation rule. The columns of from “help function” to “use of multiple figures” in the table indicate specific UI effect realizing organizations, respectively. That is, the “help function” indicates an organization having a help function and “explanation of an operation flow using a moving image” indicates an organization for explaining an operation flow using a moving image. In the table, the columns of from “resolution level” to “design level” indicate specific UI effect realizing organizations by numerical values described in the rows, respectively. That is, the “resolution level” indicates a resolution level by the numerical value described in each row. For example, “3” indicates a resolution level of “high”, “2” indicates a resolution level of “middle”, and “1” represents a resolution level of “low”. In the “mounting platform”, the numerical value described in each row is correlated with a specific mounting platform. For example, “3” is correlated with “Ajax”, “2” is correlated with “Silverlight”, and “1” is correlated with “HTML”. The “design level” indicates a design level correlated with the numerical value described in each row. For example, “2” indicates a design level of “high” (for example, an image is used as a button or a shade) and “1” indicates a design level of “low” (for example, expression with HTML and simple expression with more or less images). The numerical values which can be described in the organization-effect correlation rule are not limited to “1” to “3”, but other numerical values and more numerical values may be used. For example, with the above-mentioned configuration, the UI effect realizing organizations can be described in the organization-effect correlation rule.

In the section of the UI effect in the organization-effect correlation rule shown in FIG. 2, UI effects are arranged which are realized by the described UI effect realizing organizations. In the table, UI effects which are realized by the UI effect realizing organizations are correlated with the UI effect realizing organizations by “1” to “3” described in the table, respectively. That is, in the shown table, for example, the “help function” realizes the UI effects of “sufficient operation support” and “information on a screen is easily understood”. “Design level: 1 (for example: low)” realizes a UI effect of “comfortable for eyes”. “Design level: 2 (for example, high)” realizes a UI effect of “being easily familiar”.

The number of UI effects correlated with one UI effect realizing organization may be one or two or more. The number of UI effect realizing organizations correlated with one UI effect may be one or two or more.

Referring to FIG. 1 again, the characteristic-effect correlation rule storage unit 12 stores a characteristic-effect correlation rule in which at least one UI effect to be held by the UI screen used by an assumed user having each assumed user characteristic is correlated with each of plural assumed user characteristics.

The assumed user characteristics include all information indicating characteristics of assumed users. For example, an assumed user characteristic can be determined by an “item” (such as age and gender)” and specific “values” (such as˜13 years and male). The “item” may include a ratio of foreigners in the assumed users, a male-female ratio, and the like, in addition to information indicating characteristics of the individual assumed users. In addition, the “item” may include an area of influence when an assumed user makes a mistake. In this case, the “value” may be set, for example, to large, middle, and small. In addition, the “item” may include a place in which an assumed user does a job using the UI screen. In this case, the “value” may be set to a one-hand operation, a touch pen operation, and a mouse operation. The “item” may include restrictions to a terminal used by an assumed user. In this case, the “value” may be set to a notebook PC, a mobile terminal, and a dedicated terminal. The “item” may include an amount of data treated by an assumed user, for example, in a job. In this case, the “value” may be set to large, middle, and small. The “item” may include a frequency at which an assumed user does a job using a UI screen. In this case, the “value” may be set to large, middle, and small. The “item” may include a frequency at which an assumed user does a job using the UI screen. In this case, the “value” may be set to large, middle, and small.

What item and value should be determined as assumed user characteristics is matters which can be determined by a person preparing the characteristic-effect correlation rule, but it is preferable that details thereof be set to details which can have an influence on design change of a UI screen.

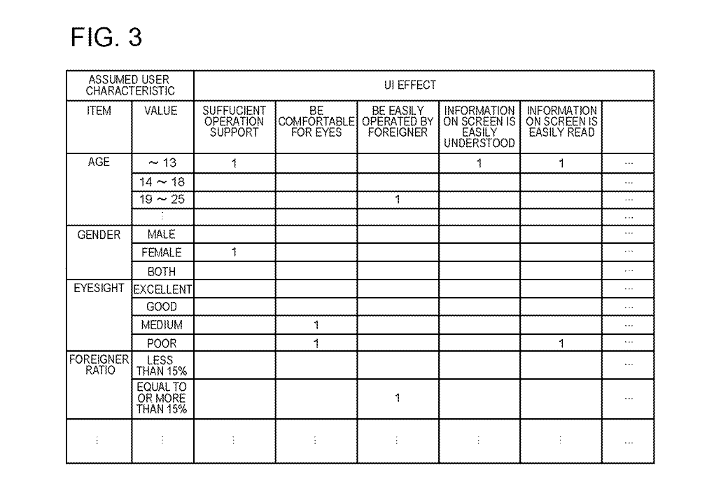

An example of the characteristic-effect correlation rule stored in the characteristic-effect correlation rule storage unit 12 is shown in FIG. 3. Items and values indicating assumed user characteristics are arranged in the column of assumed user characteristics. The UI effects described din the organization-effect correlation rule shown in FIG. 2 are arranged in the column of UI effect. In the table, by giving the value of “1”, the UI effect to be held by a UI screen used by an assumed user having each assumed user characteristic is correlated with the corresponding assumed user characteristic. That is, in the table shown in the drawing, it is shown that the UI screen used by an assumed user of which the age is equal to or less than 13 years should hold the UI effects of “sufficient operation support”, “information on a screen is easily understood”, and “information on a screen is easily read”.

The number of UI effects correlated with one assumed user characteristic may be one or two or more. The number of assumed user characteristics correlated with one UI effect may be one or two or more.

Referring to FIG. 1 again, the characteristic-classification correlation rule storage unit 14 stores a characteristic-classification correlation rule in which at least one assumed user characteristic of an assumed user belonging to each assumed user classification is correlated with the corresponding assumed user classification used to classify assumed users using a UI screen into plural groups.

Examples of the assumed user classification include “adult”, “university student”, “junior and senior high-school student”, “female high-school student”, “manager”, “general citizen”, “general consumer”, “office worker”, “IT engineer”, “old person”, “foreigner”, and “medical service worker”. The details of the assumed user classification are matters which can be determined by a person preparing the characteristic-classification correlation rule, but it is preferable that whether the details be set to details with which an assumed user belongs to the assumed user classification can have an influence on design and change of a UI screen.

Plural assumed user classifications do not need to be determined so that an assumed user belongs to only one assumed user classification, but plural assumed user classifications may be determined so that an assumed user can belong to plural assumed user classifications. For example, when all the details described above are determined as the assumed user classifications, a certain assumed user can belong to “adult”, “general citizen”, “general consumer”, “office worker”, and “IT engineer”, which does not cause any particular problem.

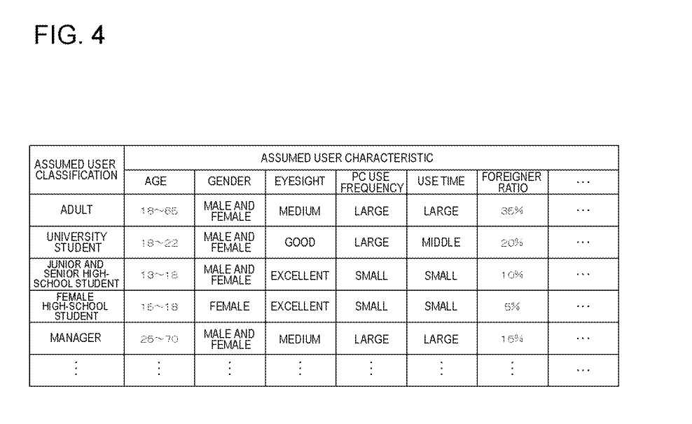

An example of the characteristic-classification correlation rule stored in the characteristic-classification correlation rule storage unit 14 is shown in FIG. 4. Items and values of the assumed user characteristics described in the characteristic-effect correlation rule shown in FIG. 3 are described in the column of assumed user characteristic. Plural assumed user classifications are described in the column of assumed user classification. In the table shown in the drawing, the assumed user characteristics of the assumed user classification “adult” indicate that the age is “18 to 65 years”, the gender “male and female”, the eyesight is “medium”, the PC use frequency is “large”, the PC use time is “large”, and the foreigner ratio is “35%”. The value of each item of the assumed user characteristics is a value which can be determined on the assumption of a standard person belonging to each assumed user classification and may be a value calculated, for example, using an examination result of questionnaire or the like for plural persons.

Referring to FIG. 1 again, the user input receiving unit 16 receives an input of specification information which is information for specifying at least one UI effect to be held by a UI screen from a design user. The user input receiving unit 16 according to this embodiment receives an input of at least one assumed user classification to which an assumed user using a UI screen belongs as the specification information. For example, the user input receiving unit 16 may store information for identifying plural assumed user classifications in advance and may receive an input of selecting at least one assumed user classification out of the plural assumed user classifications identified by the information.

As a case where an input of two or more assumed user classifications is received, for example, a case where the number of assumed users is two or more and assumed users belonging to different assumed user classifications are included in the plural assumed users or a case where one assumed user belongs to plural assumed user classifications can be considered.

A unit that allows the user input receiving unit 16 to receive an input of an assumed user classification is not particularly limited, and may be embodied through the use of a UI screen including graphical user interface (GUI) components such as a check box and a drop-down list using all input devices such as a mouse, a keyboard, and a touch panel display.

The assumed user characteristic determining unit 15 retrieves the characteristic-classification correlation rule (see FIG. 4) using the assumed user classification, of which the input is received by the user input receiving unit 16, as a key. The assumed user characteristic determining unit 15 extracts the assumed user characteristic correlated with the key and determines the extracted assumed user characteristic as the assumed user characteristic of the assumed user.

When the user input receiving unit 16 receives an input of plural assumed user classifications, the assumed user characteristic determining unit 15 may retrieve the characteristic-classification correlation rule using the plural assumed user classifications as a key and may determine all the extracted assumed user characteristics as the assumed user characteristic of the assumed user. In this case, for example, when the user input receiving unit 16 receives an input of “junior and senior high-school student” and “female high-school student” as the assumed user classifications, the age of the assumed user determined on the basis of the characteristic-classification correlation rule shown in FIG. 4 is “13 years to 18 years”, the gender is “female and both (male and female)”, the eyesight is “excellent”, “the PC use frequency is “small”, the PC use time is “small”, and the foreigner ratio is “5%, 10%”.

The UI effect determining unit 13 retrieves the characteristic-effect correlation rule (see FIG. 3) using the assumed user characteristic determined by the assumed user characteristic determining unit 15 as a key. The UI effect determining unit 13 extracts the UI effect correlated with the key and determines the extracted UI effect as a UI effect to be held by the UI screen.

An example in which the user input receiving unit 16 receives an input of “adult” as the assumed user classification and the assumed user characteristic determining unit 15 determines the assumed user characteristic such as the age of “18 years to 65 years” and the gender of “both (male and female)” on the basis of the characteristic-classification correlation rule (see FIG. 4) is considered. In this case, the UI effect determining unit 13 retrieves the characteristic-effect correlation rule (see FIG. 3), for example, using the gender of “both” as a key and extracts the UI effect correlated with the gender of “both”.

The UI effect determining unit retrieves the characteristic-effect correlation rule (see FIG. 3), for example, the age of “18 years to 65 years” and extracts the UI effect correlated with the assumed user characteristic including any age in “18 years to 65 years”, for example, the assumed user characteristics of the age such as “14 years to 18 years” and “19 years to 25 years” in the example shown in FIG. 3.

The UI effect realizing organization determining unit 11 retrieves the organization-effect correlation rule (see FIG. 2) using the UI effect determined on the basis of the specification information of which the input is received by the user input receiving unit 16 as a key. The UI effect realizing organization determining unit 11 according to this embodiment uses the UI effect determined by the UI effect determining unit 13 as a key for retrieving the organization-effect correlation rule (see FIG. 2). The UI effect realizing organization determining unit 11 extracts the UI effect realizing organization correlated with the key and determines the extracted UI effect realizing organization as the UI effect realizing organization to be given to the UI screen. The determined UI effect realizing organization may be stored in a storage unit and the design user may freely use the data.

The UI screen creating unit 17 creates a UI screen including the UI effect realizing organization determined by the UI effect realizing organization determining unit 11. The configuration of the UI screen creating unit 17 can be embodied on the basis of the related art. For example, modules for realizing the respective UI effect realizing organizations may be stored in a storage unit in advance and the UI screen creating unit 17 may create a UI screen including the UI effect realizing organization determined by the UI effect realizing organization determining unit 11.

A process flow of a UI creation support method realized by the UI creation support system according to this embodiment will be described below.

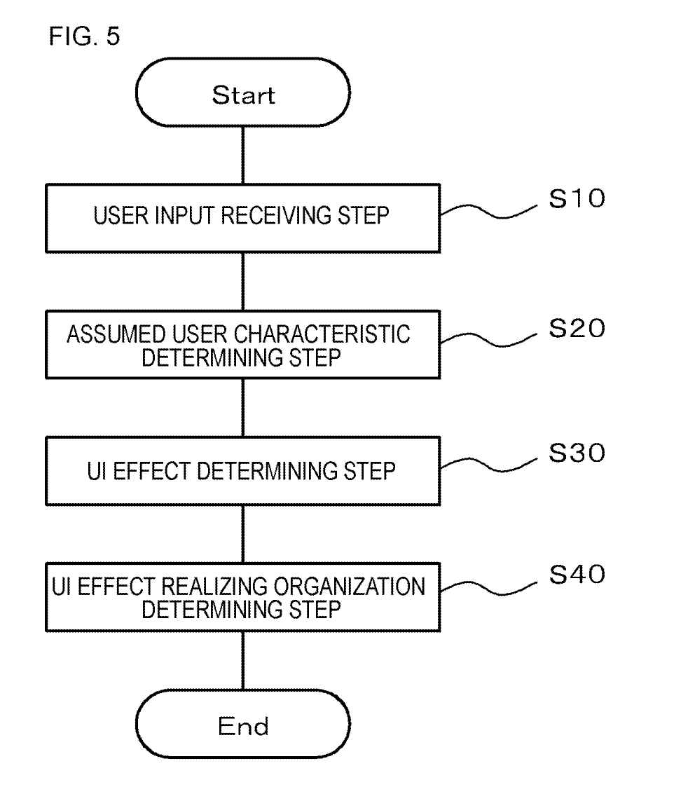

As shown in the flowchart of FIG. 5, the UI creation support method according to this embodiment includes a user input receiving step S10, an assumed user characteristic determining step S20, a UI effect determining step S30, and a UI effect realizing organization determining step S40.

In the user input receiving step S10, the user input receiving unit 16 receives specification information which is information for specifying at least one UI effect to be held by a UI screen from a design user. In this embodiment, the user input receiving unit 16 receives an input of at least one assumed user classification as the specification information.

In the assumed user characteristic determining step S20, the assumed user characteristic determining unit 15 retrieves the characteristic-classification correlation rule (see FIG. 4) using the assumed user classification of which the input is received by the user input receiving unit 16 in step S10 as a key, extracts the assumed user characteristic correlated with the key, and determines the extracted assumed user characteristic as the assumed user characteristic of the assumed user.

In the UI effect determining step S30, the UI effect determining unit 13 retrieves the characteristic-effect correlation rule (see FIG. 3) using the assumed user characteristic determined by the assumed user characteristic determining unit 15 in step S20 as a key, extracts the UI effect correlated with the key, and determines the extracted UI effect as the UI effect to be held by the UI screen.

In the UI effect realizing organization determining step S40, the UI effect realizing organization determining unit 11 retrieves the organization-effect correlation rule (see FIG. 2) using the UI effect determined by the UI effect determining unit 13 in step S30 as a key, extracts the UI effect realizing organization correlated with the key, and determines the extracted UI effect realizing organization as the UI effect realizing organization to be given to the UI screen.

Thereafter, the UI effect realizing organization determined by the UI effect realizing organization determining unit 11 may be output from the design user through the use of all the output devices such as a display and a printer.

Although the design user and the assumed user are distinguished in the above description, the design user and the assumed user may be different from each other or may be equal to each other. This assumption is true of all the following embodiments.

The UI creation support system 1 according to this embodiment can be embodied, for example, by installing the following program in a computer:

A program that supports creation of a UI screen, causing a computer to serve as: an organization-effect correlation rule storage unit that stores an organization-effect correlation rule in which at least one UI effect that is realized by a plurality of UI effect realizing organizations which can be given to the UI screen is correlated with each of the plurality of UI effect realizing organizations; a user input receiving unit that receives specification information, which is information for specifying at least one UI effect to be held by the UI screen, from a design user who is a user creating the UI screen; and a UI effect realizing organization determining unit that retrieves the organization-effect correlation rule using the UI effect specified by the specification information of which the input is received by the user input receiving unit as a key and that extracts the UI effect realizing organization correlated with the key.

Operational advantages of this embodiment will be described below.

According to this embodiment, a design user can determine UI effect realizing organization to be held by the UI screen for an assumed user by only inputting an assumed user classification to which the assumed user using the UI screen under design to the UI creation support system according to this embodiment.

According to this embodiment, a design user can determine a UI effect realizing organization to be held by the UI screen for an assumed user as long as the design user can specify at least an assumed user classification to which the assumed user belongs even in a situation where details of the assumed user cannot be understood.

According to this embodiment, even a design user poorly skilled at a UI screen can efficiently design an effective UI screen.

It is thought that it is a very troublesome, time-requiring, and labor-requiring job for a design user skilled at a UI screen to review the respective UI effect realizing organizations and to whether each UI effect realizing organization should be included by a UI screen. According to this embodiment, for example, a design user can first prepare a first scheme of the UI effect realizing organizations to be included by a UI screen under design using the UI creation support system according to this embodiment and then can delete or add the UI effect realizing organizations of the UI screen under design. From these points of views, according to this embodiment, it is possible to reduce time and labor in designing a UI screen.

### Second Embodiment

This embodiment is different from the first embodiment, in that the user input receiving unit 16 receives an input of “assumed user characteristic” from a design user.

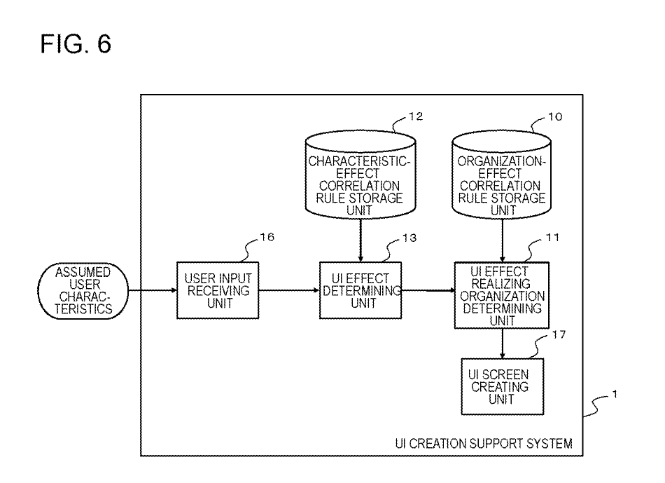

FIG. 6 is a functional block diagram illustrating an example of a configuration of the UI creation support system 1 according to this embodiment. The UI creation support system 1 according to this embodiment includes an organization-effect correlation rule storage unit 10, a UI effect realizing organization determining unit 11, a characteristic-effect correlation rule storage unit 12, a UI effect determining unit 13, a user input receiving unit 16, and a UI screen creating unit 17. The UI screen creating unit 17 may not be provided.

The organization-effect correlation rule storage unit 10, the UI effect realizing organization determining unit 11, the characteristic-effect correlation rule storage unit 12, and the UI screen creating unit 17 are the same as described in the first embodiment.

The user input receiving unit 16 receives an input of at least one assumed user characteristic of an assumed user using a UI screen as the specification information from a design user.

The UI effect determining unit 13 retrieves the characteristic-effect correlation rule using the assumed user characteristic of which the input is received by the user input receiving unit 16 as a key. Then, the UI effect determining unit 13 extracts the UI effect correlated with the key and determines the extracted UI effect as the UI effect to be held by the UI screen.

The UI creation support system 1 according to this embodiment may be configured not to include the characteristic-classification correlation rule storage unit and the assumed user characteristic determining unit as shown in FIG. 6, or may be configured to include the characteristic-classification correlation rule storage unit 14 and the assumed user characteristic determining unit 15 as shown in FIG. 1, similarly to the first embodiment.

When the configuration shown in FIG. 1 is employed, the user input receiving unit 16 may be configured to selectively receive a user input of any of an assumed user classification and an assumed user characteristic. In this case, the design user can freely select information to be input to the UI creation support system 1 depending on the understood situations for assumed users using the UI screen under design.

According to this embodiment, the same operational advantages as described in the first embodiment can be achieved.

That is, according to this embodiment, a design user of a UI screen can determine a UI effect realizing organization to be held by the UI screen for an assumed user by inputting the assumed user characteristic of the assumed user using the UI screen under design to the UI creation support system according to this embodiment.

According to this embodiment, a design user can determine a UI effect realizing organization to be held by the UI screen for an assumed user as long as the design user can specify at least an assumed user classification to which the assumed user belongs even in a situation where details of the assumed user cannot be understood.

When the UI creation support system 1 according to this embodiment has the configuration shown in FIG. 1, a design user can select information (an assumed user classification or an assumed user characteristic) to be input to the UI creation support system according to this embodiment depending on the understood situations for an assumed user. According to this embodiment, the number of options of the information to be input by the design user increases, thereby achieving a system having high convenience to the design user.

### Third Embodiment

This embodiment is different from the first and second embodiments, in that the user input receiving unit 16 receives an input of “UI effect” from a design user.

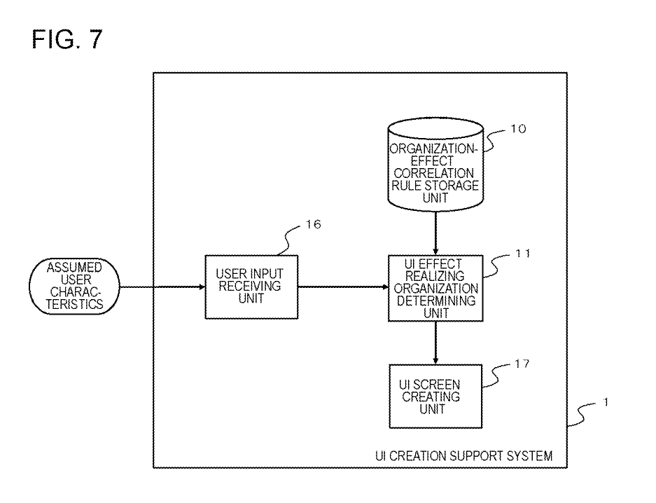

FIG. 7 is a functional block diagram illustrating an example of a configuration of the UI creation support system 1 according to this embodiment. The UI creation support system 1 according to this embodiment includes an organization-effect correlation rule storage unit 10, a UI effect realizing organization determining unit 11, a user input receiving unit 16, and a UI screen creating unit 17. The UI screen creating unit 17 may not be provided.

The organization-effect correlation rule storage unit 10 and the UI screen creating unit 17 are the same as described in the first embodiment.

The user input receiving unit 16 receives an input of at least one UI effect to be held by a UI screen as specification information from a design user.

The UI effect realizing organization determining unit 11 retrieves the organization-effect correlation rule using the UI effect of which the input is received by the user input receiving unit 16 as a key. Then, the UI effect realizing organization determining unit 11 extracts the UI effect realizing organization correlated with the key and determines the extracted UI effect realizing organization as the UI effect realizing organization to be given to the UI screen.

The UI creation support system 1 according to this embodiment may be configured not to include the characteristic-effect correlation rule storage unit, the UI effect determining unit, the characteristic-classification correlation rule storage unit, and the assumed user characteristic determining unit as shown in FIG. 7, or may be configured to include the characteristic-effect correlation rule storage unit 12, the UI effect determining unit 13, the characteristic-classification correlation rule storage unit 14, and the assumed user characteristic determining unit 15 as shown in FIG. 1, similarly to the first embodiment. Similarly to the second embodiment, as shown in FIG. 6, the UI creation support system may be configured not to include the characteristic-classification correlation rule storage unit and the assumed user characteristic determining unit but to include the characteristic-effect correlation rule storage unit 12 and the UI effect determining unit 13.

When the configuration shown in FIG. 1 is employed, the user input receiving unit 16 may be configured to selectively receive a user input of any of an assumed user classification and an assumed user characteristic. When the configuration shown in FIG. 6 is employed, the user input receiving unit 16 may be configured to selectively receive a user input of any of an assumed user characteristic and a UI effect. In this case, the design user can freely select information to be input to the UI creation support system 1 depending on the understood situations for assumed users using the UI screen under design.

According to this embodiment, the same operational advantages as described in the first and second embodiments can be achieved.

That is, according to this embodiment, a design user of a UI screen can determine a UI effect realizing organization to be held by the UI screen for an assumed user in inputting the UI effect to be held by the UI screen under design to the UI creation support system according to this embodiment.

According to this embodiment, a design user can determine an appropriate UI effect realizing organization to be held by the UI screen for an assumed user even when the UI effect realizing organization for realizing the UI effect cannot be specified, as long as the design user can understand an assumed user and specify a UI effect to be provided to the assumed user.

That is, according to this embodiment, even a design user poorly skilled at a UI screen can efficiently design an effective UI screen.

When the UI creation support system 1 according to this embodiment has the configuration shown in FIG. 1 or 6, a design user can select information (an assumed user classification, or an assumed user characteristic, or a UI effect) to be input to the UI creation support system according to this embodiment depending on the understood situations for an assumed user. According to this embodiment, the number of options of the information to be input by the design user increases, thereby achieving a system having high convenience to the design user.

### Fourth Embodiment

In the first to third embodiments, the assumed user characteristic determining unit 15 retrieves the characteristic-classification correlation rule using a predetermined key, extracts assumed user characteristics, and determines the extracted assumed user characteristics as the assumed user characteristics of the assumed user.

On the other hand, this embodiment is different from the first to third embodiments, in that the assumed user characteristic determining unit 15 once outputs and provides the extracted assumed user characteristics to a design user, receives an input for modifying (deleting, adding, and the like) the extracted assumed user characteristics or an input for maintaining the extracted assumed user characteristics as it were (an input for determining the extracted assumed user characteristics as the assumed user characteristics of the assumed user as it were), and determines the assumed user characteristics of the assumed user depending on the received input.

The functional block diagram illustrating an example of the configuration of the UI creation support system 1 according to this embodiment can employ any of FIGS. 1, 6, and 7. The configurations of the organization-effect correlation rule storage unit 10, the UI effect realizing organization determining unit 11, the characteristic-effect correlation rule storage unit 12, the UI effect determining unit 13, the characteristic-classification correlation rule storage unit 14, the user input receiving unit 16, and the UI screen creating unit 17 are the same as described in the first to third embodiments.

The assumed user characteristic determining unit 15 outputs the assumed user characteristics extracted from the characteristic-classification correlation rule to the design user and receives a modification input for deleting at least one of the extracted assumed user characteristics and/or adding a non-extracted assumed user characteristic thereto or a maintenance input (an input for determining the extracted assumed user characteristics as the assumed user characteristics of the assumed user as it were) for maintaining the extracted assumed user characteristics from the design user. Then, the assumed user characteristic determining unit 15 determines the assumed user characteristics of the assumed user using the UI screen depending on the input details.

A unit allowing the assumed user characteristic determining unit 15 to output the assumed user characteristics is not particularly limited, but may be embodied using all the output devices such as a display. A unit allowing the assumed user characteristic determining unit 15 to receive the modification input and the maintenance input is not also particularly limited, but may be embodied through the use of a UI screen including GUI components such as a check box using all the input devices such as a mouse, a keyboard, and a touch panel display.

According to this embodiment, the same operational advantages as described in the first to third embodiments can be achieved.

According to this embodiment, a design user of a UI screen can modify the assumed user characteristics extracted on the basis of the input assumed user classification to the assumed user characteristics more suitable for the assumed user. The UI creation support system 1 can determine the UI effect realizing organization to be given to the UI screen for the assumed user on the basis of the modified assumed user characteristics.

### Fifth Embodiment

In the first to fourth embodiments, the UI effect determining unit 13 retrieves the characteristic-classification correlation rule using a predetermined key, extracts UI effects, and determines the extracted UI effects as the UI effects to be held by the UI screen.

On the other hand, this embodiment is different from the first to fourth embodiments, in that the UI effect determining unit 13 once outputs and provides the extracted UI effects to a design user, receives an input for modifying (deleting, adding, and the like) the extracted UI effects or an input for maintaining the extracted UI effects as it were (an input for determining the extracted UI effects as the UI effects to be held by the UI screen as it were), and determines the UI effects to be held by the UI screen depending on the received input.

The functional block diagram illustrating an example of the configuration of the UI creation support system 1 according to this embodiment can employ any of FIGS. 1, 6, and 7. The configurations of the organization-effect correlation rule storage unit 10, the UI effect realizing organization determining unit 11, the characteristic-effect correlation rule storage unit 12, the characteristic-classification correlation rule storage unit 14, the assumed user characteristic determining unit 15, the user input receiving unit 16, and the UI screen creating unit 17 are the same as described in the first to fourth embodiments.

The UI effect determining unit 13 outputs the UI effects extracted from the characteristic-effect correlation rule to the design user and receives a modification input for deleting at least one of the extracted UI effects and/or adding a non-extracted UI effect thereto or a maintenance input (an input for determining the extracted UI effects as the UI effects to be held by the UI screen as it were) for maintaining the extracted UI effects from the design user. Then, the UI effect determining unit 13 determines the UI effects to be held by the UI screen depending on the input details.

A unit allowing the UI effect determining unit 13 to output the UI effects is not particularly limited, but may be embodied using all the output devices such as a display. A unit allowing the UI effect determining unit 13 to receive the modification input and the maintenance input is not also particularly limited, but may be embodied through the use of a UI screen including GUI components such as a check box using all the input devices such as a mouse, a keyboard, and a touch panel display.

According to this embodiment, the same operational advantages as described in the first to fourth embodiments can be achieved.

According to this embodiment, a design user of a UI screen can modify the UI effects extracted on the basis of the input assumed user classification or the input assumed user characteristics to the UI effects more suitable for the assumed user. The UI creation support system 1 can determine the UI effect realizing organization to be given to the UI screen for the assumed user on the basis of the modified UI effects.

### Sixth Embodiment

In the first to fifth embodiments, the UI effect realizing organization determining unit 11 retrieves the characteristic-classification correlation rule using a predetermined key, extracts UI effect realizing organizations, and determines the extracted UI effect realizing organizations as the UI effect realizing organizations to be given to the UI screen.

On the other hand, this embodiment is different from the first to fifth embodiments, in that the UI effect realizing organization determining unit 11 once outputs and provides the extracted UI effect realizing organizations to a design user, receives an input for modifying (deleting, adding, and the like) the extracted UI effect realizing organizations or an input for maintaining the extracted UI effect realizing organizations as it were (an input for determining the extracted UI effects as the UI effect realizing organizations to be given to the UI screen as it were), and determines the UI effects to be given to the UI screen depending on the received input.

The functional block diagram illustrating an example of the configuration of the UI creation support system 1 according to this embodiment can employ any of FIGS. 1, 6, and 7. The configurations of the organization-effect correlation rule storage unit 10, the characteristic-effect correlation rule storage unit 12, the UI effect determining unit 13, the characteristic-classification correlation rule storage unit 14, the assumed user characteristic determining unit 15, the user input receiving unit 16, and the UI screen creating unit 17 are the same as described in the first to fifth embodiments.

The UI effect realizing organization determining unit 11 outputs the UI effect realizing organizations extracted from the characteristic-effect correlation rule to the design user and receives a modification input for deleting at least one of the extracted UI effect realizing organizations and/or adding a non-extracted UI effect realizing organization thereto or a maintenance input (an input for determining the extracted UI effect realizing organizations as the UI effect realizing organizations to be given to the UI screen as it were) for maintaining the extracted UI effect realizing organizations from the design user. Then, the UI effect realizing organization determining unit 11 determines the UI effect realizing organizations to be given to the UI screen depending on the input details.

A unit allowing the UI effect realizing organization determining unit 11 to output the extracted UI effect realizing organizations is not particularly limited, but may be embodied using all the output devices such as a display. A unit allowing the UI effect realizing organization determining unit 11 to receive the modification input and the maintenance input is not also particularly limited, but may be embodied through the use of a UI screen including GUI components such as a check box using all the input devices such as a mouse, a keyboard, and a touch panel display.

According to this embodiment, the same operational advantages as described in the first to fifth embodiments can be achieved.

According to this embodiment, a design user can modify the UI effect realizing organizations to be given to the UI screen under design if necessary using the UI effect realizing organizations determined by the UI effect realizing organization determining unit 11 as an original scheme depending on a predetermined input. According to this embodiment, a design user can improve the design efficiency of a UI screen.

### Seventh Embodiment

This embodiment is different from the first to sixth embodiments, in that the UI effect determining unit 13 has the following features.

Plural values may be selected from any item of the assumed user characteristics, for example, by causing the assumed user characteristic determining unit 15 to extract the assumed user characteristics using plural assumed user classifications as a key or causing the assumed user characteristic determining unit 15 to receive modification of the extracted assumed user characteristics from the design user as described in the fourth embodiment. Specifically, the assumed user characteristic determining unit 15 may determine both of “good” and “poor” in the item “eyesight” of the assumed user characteristics as the assumed user characteristics of a certain assumed user.

The UI effect determining unit 13 according to this embodiment can select at least one user characteristic (value) on the basis of a predetermined priority and use only the selected user characteristic (value) as a key for retrieving the characteristic-effect correlation rule.

The functional block diagram illustrating an example of the configuration of the UI creation support system 1 according to this embodiment can employ any of FIGS. 1, 6, and 7. The configurations of the organization-effect correlation rule storage unit 10, the UI effect realizing organization determining unit 11, the characteristic-classification correlation rule storage unit 14, the assumed user characteristic determining unit 15, the user input receiving unit 16, and the UI screen creating unit 17 are the same as described in the first to sixth embodiments.

The UI effect determining unit 13 determines whether assumed user characteristics which are undesirable to coexist are included in at least one key for retrieving the characteristic-effect correlation rule, using first coexistence unallowable information in which two or more assumed user characteristics which are undesirable to coexist in the at least one key used to retrieve the characteristic-effect correlation rule are determined out of the plural assumed user characteristics included in the characteristic-effect correlation rule. When the determination result is positive, at least one assumed user characteristic to be used as the key is determined out of the two or more assumed user characteristics which are undesirable to coexist on the basis of a predetermined priority.

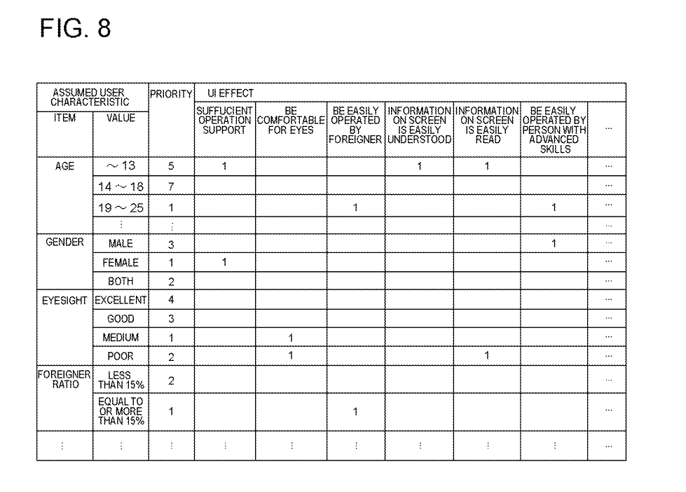

Details of the first coexistence unallowable information are not particularly limited, and an example thereof is shown in FIG. 8. In the table shown in FIG. 8, a section of priority is provided. In the section of priority, a priority is described for each item of the assumed user characteristics. In this table, it is shown that assumed user characteristics having the same item and having different values are undesirable to coexist in at least one key used to retrieve the characteristic-effect correlation rule.

The UI effect determining unit 13 determines whether keys which are undesirable to coexist are included in at least one key used to retrieve the characteristic-effect correlation rule, for example, using the first coexistence unallowable information shown in FIG. 8. When the determination result is positive, at least one assumed user characteristic to be used as the key is determined out of the two or more assumed user characteristics which are undesirable to coexist on the basis of a predetermined priority in accordance with a predetermined rule. The first coexistence unallowable information shown in FIG. 8 is stored, for example, in the characteristic-effect correlation rule storage unit 12.

Details of the rule are not particularly limited, and may be, for example, a rule using only the assumed user characteristic having the highest priority as a key or a rule using only a predetermined number (design matters) of assumed user characteristics from the highest priority as a key. The rule may be determined for each item. The rule may be determined for each item and for each UI effect.

The following configuration can be considered as a modification example of this embodiment. In the above-mentioned configuration, regarding the priorities shown in FIG. 8, one priority is given to each item. In this modification example, the priority given to each item may be added for each UI effect. That is, the priority for retrieving the column of a UI effect “sufficient operation support” may be different from the priority for retrieving the column of a UI effect “be comfortable for an eye”.

According to this embodiment, it is possible to avoid a problem in that UI effects having opposite details are called on the basis of the keys (assumed user characteristics) which are undesirable to coexist in the keys used to retrieve the characteristic-effect correlation rule and the UI effect realizing organizations are determined on the basis thereof, as well as to achieve the same operational advantages as described in the first to fifth embodiments.

It is possible to call UI effects corresponding to many assumed users, not the UI effects specialized for only a certain assumed user. For example, when the assumed user characteristics “eyesight: excellent” and “eyesight: poor” are selected, a UI screen having a UI effect realizing organization which is unnecessary for an assumed user with “eyesight: excellent” but which can be used by both the assumed users with “eyesight: excellent” and “eyesight: poor” can be designed by setting the priority of “eyesight: poor” to be high.

### Eighth Embodiment

This embodiment is different from the first to seventh embodiments, in that the UI effect realizing organization determining unit 11 has the following features.

UI effects having opposite details may be selected, for example, by causing the assumed user characteristic determining unit 15 to extract the assumed user characteristics using plural assumed user classifications as a key, or causing the assumed user characteristic determining unit 15 to receive modification of the extracted assumed user characteristics from the design user as described in the fourth embodiment and the UI effect determining unit 13 to receive modification of the extracted UI effects from the design user as described in the fifth embodiment. Specifically, the UI effect determining unit 13 may determine two UI effects of “sufficient operation support” and “be easily operated by a person with advanced skilled”.

The UI effect realizing organization determining unit 11 according to this embodiment can select at least one of the UI effects having opposite details on the basis of a predetermined priority and use only the selected UI effect as a key for retrieving the organization-effect correlation rule.

The functional block diagram illustrating an example of the configuration of the UI creation support system 1 according to this embodiment can employ any of FIGS. 1, 6, and 7. The configurations of the characteristic-effect correlation rule storage unit 12, the UI effect determining unit 13, the characteristic-classification correlation rule storage unit 14, the assumed user characteristic determining unit 15, the user input receiving unit 16, and the UI screen creating unit 17 are the same as described in the first to seventh embodiments.

The UI effect realizing organization determining unit 11 determines whether UI effects which are undesirable to coexist are included in at least one key for retrieving the organization-effect correlation rule, using second coexistence unallowable information in which two or more UI effects which are undesirable to coexist in the at least one key used to retrieve the organization-effect correlation rule are determined out of the plural UI effects included in the organization-effect correlation rule. The UI effects which are undesirable to coexist may be, for example, the UI effects having opposite details.

When the UI effects which are undesirable to coexist are included, the UI effect realizing organization determining unit 11 determines at least one UI effect to be used as a key out of the two or more UI effects which are undesirable to coexist on the basis of a predetermined priority.

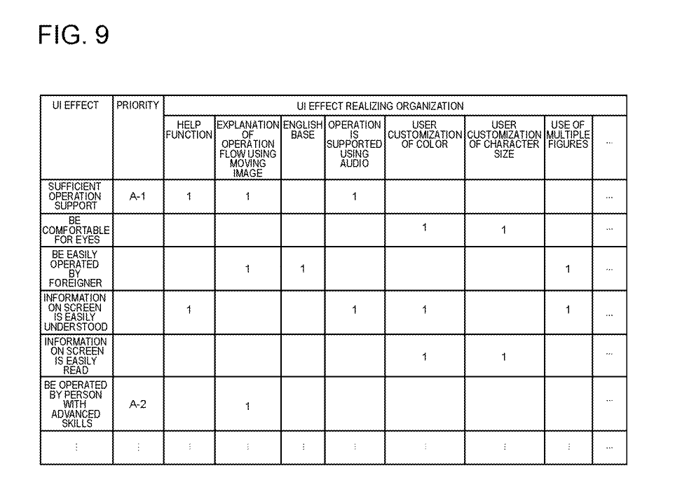

Details of the second coexistence unallowable information are not particularly limited, and an example thereof is shown in FIG. 9. In the table shown in FIG. 9, a section of priority is provided. In the section of priority, signs having an alphabet and a number combined, such as “A-1”, are recorded. From the table, it can be seen that the UI effects having the same alphabet are undesirable to coexist in at least one key used to retrieve the organization-effect correlation rule. The number combined with the alphabet indicates the priority. According to this table, the UI effects of “sufficient operation support” and “be easily operated by a person with advanced skills” are undesirable to coexist in at least one key used to retrieve the organization-effect correlation rule. The UI effect “sufficient operation support” has a higher priority than that of the UI effect “be easily operated by a person with advanced skills”.

The UI effect realizing organization determining unit 11 determines whether keys which are undesirable to coexist are included in at least one key used to retrieve the organization-effect correlation rule, for example, using the second coexistence unallowable information shown in FIG. 9. When the determination result is positive, at least one UI effect to be used as the key is determined out of the two or more UI effects which are undesirable to coexist on the basis of a predetermined priority in accordance with a predetermined rule. The second coexistence unallowable information shown in FIG. 9 is stored, for example, in the organization-effect correlation rule storage unit 10.

Details of the rule are not particularly limited, and may be, for example, a rule using only the UI effect having the highest priority as a key or a rule using only a predetermined number (design matters) of UI effects from the highest priority as a key. The rule may be determined for each group including plural UI effects to which the same alphabet is given in the section of priority. The rule may be determined for each group and for each UI effect realizing organization.

The following configuration can be considered as a modification example of this embodiment. That is, the priorities given to the UI effects may be given for each UI effect realizing organization. That is, the priority for retrieving the column of a UI effect realizing organization “help function” may be different from the priority for retrieving the column of a UI effect realizing organization “explanation of an operation flow using a moving image”.

In another modification example, a priority may be given to the assumed user classifications of the characteristic-classification correlation rule shown in FIG. 4, similarly to the above-mentioned configuration.

According to this embodiment, it is possible to avoid a problem in that the UI effect realizing organizations are determined on the basis of the UI effects having opposite details, as well as to achieve the same operational advantages as described in the first to seventh embodiments.

Priority is claimed on Japanese Patent Application No. 2011-015439, filed on Jan. 27, 2011, the content of which is incorporated herein by reference.

1. A UI creation support system that supports creation of a user interface (UI) screen, comprising:
an organization-effect correlation rule storage unit that stores an organization-effect correlation rule in which at least one UI effect that is realized by a plurality of UI effect realizing organizations which can be given to the UI screen is correlated with each of the plurality of UI effect realizing organizations;
a user input receiving unit that receives specification information, which is information for specifying at least one UI effect to be held by the UI screen, from a design user who is a user creating the UI screen; and
a UI effect realizing organization determining unit that retrieves the organization-effect correlation rule using the UI effect specified by the specification information of which the input is received by the user input receiving unit as a key and that extracts the UI effect realizing organization correlated with the key.

2. The UI creation support system according to claim 1, further comprising a UI screen creating unit that creates the UI screen having the UI effect realizing organization extracted by the UI effect realizing organization determining unit.

3. The UI creation support system according to claim 1, further comprising a characteristic-effect correlation rule storage unit that stores a characteristic-effect correlation rule in which each of a plurality of assumed user characteristics indicating characteristics of an assumed user who is a user using the UI screen is correlated with at least one UI effect to be held by the UI screen used by the assumed user having each assumed user characteristic,
wherein the user input receiving unit receives an input of at least one assumed user characteristic of the assumed user as the specification information,
wherein the UI creation support system further comprises a UI effect determining unit that retrieves the characteristic-effect correlation rule using the assumed user characteristic, of which the input is received by the user input receiving unit, as a key, that extracts the UI effect correlated with the key, and that determines the extracted UI effect as the UI effect to be held by the UI screen, and
wherein the UI effect realizing organization determining unit uses the UI effect determined by the UI effect determining unit as a key for retrieving the organization-effect correlation rule.

4. The UI creation support system according to claim 3, wherein the UI effect determining unit outputs the UI effect extracted from the characteristic-effect correlation rule to the design user, receives a modification input of deleting at least one of the extracted UI effects and/or adding the UI effect not extracted to the extracted UI effects or a maintenance input of not changing the extracted UI effect, and determines the UI effect to be held by the UI screen on the basis of details of the input.

5. The UI creation support system according to claim 1, wherein the user input receiving unit receives an input of at least one UI effect to be held by the UI screen as the specification information.

6. The UI creation support system according to claim 1, further comprising:
a characteristic-effect correlation rule storage unit that stores a characteristic-effect correlation rule in which each of a plurality of assumed user characteristics indicating characteristics of an assumed user who is a user using the UI screen is correlated with at least one UI effect to be held by the UI screen used by the assumed user having each assumed user characteristic; and
a characteristic-classification correlation rule storage unit that stores a characteristic-classification correlation rule in which each of assumed user classifications into which the assumed users are classified is correlated with at least one assumed user characteristics of the assumed users belonging to the corresponding assumed user classification,
wherein the user input receiving unit receives an input of at least one assumed user classification, to which the assumed user belongs, as the specification information,
wherein the UI creation support system further comprises:
an assumed user characteristic determining unit that retrieves the characteristic-classification correlation rule using the assumed user classification, of which the input is received by the user input receiving unit, as a key, that extracts the assumed user characteristic correlated with the key, and that determines the extracted assumed user characteristic as the assumed user characteristic of the assumed user; and
a UI effect determining unit that retrieves the characteristic-effect correlation rule using the assumed user characteristic, which is determined by the assumed user characteristic determining unit, as a key, that extracts the UI effect correlated with the key, and that determines the extracted UI effect as the UI effect to be held by the UI screen, and
wherein the UI effect realizing organization determining unit uses the UI effect determined by the UI effect determining unit as a key for retrieving the organization-effect correlation rule.

7. The UI creation support system according to claim 6, wherein the assumed user characteristic determining unit outputs the assumed user characteristic extracted from the characteristic-classification correlation rule to the design user, receives a modification input of deleting at least one of the extracted assumed user characteristics and/or adding the assumed user characteristic not extracted to the extracted assumed user characteristics or a maintenance input of not changing the extracted assumed user characteristic, and determines the assumed user characteristic of the assumed user on the basis of details of the input.

8. The UI creation support system according to claim 6, wherein the UI effect determining unit outputs the UI effect extracted from the characteristic-effect correlation rule to the design user, receives a modification input of deleting at least one of the extracted UI effects and/or adding the UI effect not extracted to the extracted UI effects or a maintenance input of not changing the extracted UI effect, and determines the UI effect to be held by the UI screen on the basis of details of the input.

9. The UI creation support system according to claim 6, wherein the UI effect realizing organization determining unit outputs the UI effect realizing organization extracted from the organization-effect correlation rule to the design user, receives a modification input of deleting at least one of the extracted UI effect realizing organizations and/or adding the UI effect realizing organization not extracted to the extracted UI effect realizing organizations or a maintenance input of not changing the extracted UI effect realizing organization, and determines the UI effect realizing organization to be given to the UI screen on the basis of details of the input.

10. The UI creation support system according to claim 3, wherein the UI effect determining unit determines whether the assumed user characteristics which are undesirable to coexist are included in at least one key used to retrieve the characteristic-effect correlation rule using first coexistence unallowable information in which two or more assumed user characteristics which are undesirable to coexist in the at least one key used to retrieve the characteristic-effect correlation rule are determined out of the plurality of assumed user characteristics included in the characteristic-effect correlation rule, and determines the assumed user characteristic to be used as the key out of the two or more assumed user characteristics which are undesirable to coexist on the basis of a predetermined priority when the determination result is positive.

11. The UI creation support system according to claim 1, wherein the UI effect realizing organization determining unit determines whether the UI effects which are undesirable to coexist are included in at least one key used to retrieve the organization-effect correlation rule using second coexistence unallowable information in which two or more UI effects which are undesirable to coexist in the at least one key used to retrieve the organization-effect correlation rule are determined out of the plurality of UI effects included in the organization-effect correlation rule, and determines the UI effect to be used as the key out of the two or more UI effects which are undesirable to coexist on the basis of a predetermined priority when the determination result is positive.

12. A UI creation support method of supporting creation of a UI screen which is processed by a computer:
wherein the computer stores an organization-effect correlation rule in which at least one UI effect that is realized by a plurality of UI effect realizing organizations which can be given to the UI screen is correlated with each of the plurality of UI effect realizing organizations;
the UI creation support method comprising:
a user input receiving step of receiving specification information, which is information for specifying at least one UI effect to be held by the UI screen, from a design user who is a user creating the UI screen; and
a UI effect realizing organization determining step of retrieving the organization-effect correlation rule using the UI effect specified by the specification information of which the input is received in the user input receiving step as a key and extracting the UI effect realizing organization correlated with the key.

13. A non-transitory storage medium storing a program that supports creation of a UI screen, causing a computer to serve as:
an organization-effect correlation rule storage unit that stores an organization-effect correlation rule in which at least one UI effect that is realized by a plurality of UI effect realizing organizations which can be given to the UI screen is correlated with each of the plurality of UI effect realizing organizations;
a user input receiving unit that receives specification information, which is information for specifying at least one UI effect to be held by the UI screen, from a design user who is a user creating the UI screen; and
a UI effect realizing organization determining unit that retrieves the organization-effect correlation rule using the UI effect specified by the specification information of which the input is received by the user input receiving unit as a key and that extracts the UI effect realizing organization correlated with the key.
